(19) United States
(12) Patent Application Publication
(10) Pub. No.: US 2023/0282932 A1
(43) Pub. Date: Sep. 7, 2023

(54) MANUFACTURING METHOD FOR SEPARATOR OF LITHIUM METAL SECONDARY BATTERY AND LITHIUM METAL SECONDARY BATTERY MANUFACTURED BY USING THE SAME

(71) Applicant: Industry-University Cooperation Foundation Hanyang University ERICA Campus, Ansan-si (KR)

(72) Inventors: Kuk Young CHO, Ansan-si (KR); Jin Sol IM, Ansan-si (KR); Jin Hyeok AHN, Ansan-si (KR); Ju Yeon IM, Ansan-si (KR)

(21) Appl. No.: 18/109,459

(22) Filed: Feb. 14, 2023

(30) Foreign Application Priority Data
Feb. 15, 2022 (KR) 10-2022-0019239

(51) Int. Cl. H01M 50/403

(52) U.S. Cl. CPC H01M 50/403

(57) ABSTRACT

The present disclosure relates to a method for manufacturing a separator for a lithium metal secondary battery, and a lithium metal secondary battery manufactured using the same, and specifically, to a method for manufacturing a separator for a lithium metal secondary battery, and a lithium metal secondary battery manufactured using the same, which suppress the growth of lithium dendrite and improve the stability, durability and electrical conductivity of a lithium metal secondary battery by coating a porous substrate with a thin film coating layer containing organic and inorganic materials.

### TECHNICAL FIELD

This application claims the benefit of Korean Patent Application No. 10-2022-0019239, filed with the Korean Intellectual Property Office on Feb. 15, 2022, the contents of which are incorporated herein by reference in their entirety.

The present disclosure relates to a method for manufacturing a separator for a lithium metal secondary battery, and a lithium metal secondary battery manufactured using the same, and specifically, to a method for manufacturing a separator for a lithium metal secondary battery, and a lithium metal secondary battery manufactured using the same, which suppress the growth of lithium dendrite and improve the stability, durability, and the like of a lithium metal secondary battery by coating a porous substrate with a thin film coating layer containing organic and inorganic materials.

### BACKGROUND ART

Conventional lithium secondary batteries have used, as a negative electrode material, a carbon-based active material which has been commercialized because of its several excellent characteristics, though the theoretical capacity is as limited as 372 mAh/g.

However, in order to implement a large-capacity battery, high capacity and high energy density should be implemented, and thus the carbon-based active material is considered not suitable for satisfying such characteristics.

Recently, in order to overcome the above-mentioned problems, various researches on negative electrode materials are being conducted, and among them, a lithium metal secondary battery using lithium metal itself as a negative electrode is attracting the most attention. When lithium metal itself is used as a negative electrode, it is possible to secure an excellent capacity (3760 mAh/g) and a low lithium reaction potential, enabling the realization of a secondary battery with high capacity and high energy density.

Lithium secondary batteries, including lithium metal batteries, are basically constituted with a negative electrode, a positive electrode, a separator, and an electrolyte. Particularly, when lithium is applied as a negative electrode, stability and long-term driving performance should be secured. The separator plays a role of presenting a passage of lithium ions while preventing short circuit due to physical contact between two electrodes, but when lithium metal is used as the negative electrode, the characteristics of the general and unmodified separator itself have limitations in terms of short-circuit problems due to the growth of lithium dendrite, and the obtaining of long-term driving performance of the battery.

Conventional technologies related to the suppression of growth of lithium dendrite, which is a problem of lithium metal batteries, or the modification of the separator for the long-term driving performance, are as follows.

In order to recycle the lithium that has been cut off from the conventional lithium negative electrode so that this isolated lithium can play the role of the negative electrode again, gold is applied to the separator for conductivity through sputtering, which provides an effect of increasing the recovery rate of lithium by recycling the electrically isolated lithium. However, this method has a limitation in that an environment control step for the process, such as the creation of a vacuum atmosphere for sputtering drive, should be added.

Additionally, a sandwich-type separator has been made by heat-melting or compressing a separator/porous ceramic coating layer/separator in order to make it thermally and mechanically stable, to have high electrolyte solution wettability, and to stabilize the lithium/separator interface by suppressing the growth of dendrite, and has provided an effect of improving electrochemical performance and stability. However, this method has a problem in that the energy density of the battery is reduced because two separators and the inorganic coating layer with a thickness of 2 to 3 μm are used.

Furthermore, in order to prevent dendrite growth in lithium metal, Cu was applied and coated on the separator through sputtering, and Li deposited uniformly on the applied copper provided an effect of suppressing the dendrite growth on the lithium negative electrode. However, this method has a limitation in that an environment control step for the process, such as the creation of a vacuum atmosphere for sputtering drive, should be added.

Accordingly, there is a strong need to conduct more researches and studies on a method for manufacturing a separator for a lithium metal secondary battery, and a lithium metal secondary battery manufactured using the same, which enable the separator to be manufactured at room temperature and/or atmospheric pressure without employing extreme environments such as vacuum conditions during the manufacture, while maintaining energy density by not increasing the weight and volume of the separator, and which can improve the characteristics directly related to the performance of lithium secondary batteries, such as heat resistance, electrical conductivity of separators, and the like, and can suppress the formation of dendrite in lithium metal batteries.

### DISCLOSURE

### Technical Problem

The technical object to be achieved by the present disclosure is to provide a method for manufacturing a separator for a lithium metal secondary battery, and a lithium metal secondary battery manufactured using the same, which are capable of maintaining energy density, of enabling their manufacture under mild conditions, and of improving heat resistance and electrical conductivity by forming a coating layer on a porous substrate through gas phase polymerization of a mixture including a conductive monomer and an inorganic precursor in order to alleviate the performance degradation and safety issue of secondary batteries caused by the growth and side reactions of lithium dendrite growing on the surface of lithium metal.

However, the objects to be addressed by the present disclosure are not limited to the above-mentioned one, and other objects not mentioned above will be clearly appreciated by those skilled in the art from the following description.

### Technical Solution

An embodiment of the present disclosure provides a method for manufacturing a separator for a lithium metal secondary battery, the method including: applying an oxidizing agent to a porous substrate having pores such that the pores are maintained; and performing gas phase polymerization of a mixture including a conductive monomer and an inorganic precursor on the porous substrate, such that a coating layer including a conductive polymer resin and an inorganic material is formed on at least a part of the porous substrate.

According to an embodiment of the present disclosure, the oxidizing agent may include one selected from the group consisting of FeCl₃, iron( [symbol] ) p-toluenesulfonate (ferric ( [symbol] ) p-toluenesulfonate), CuCl₃, Cu(ClO₄)₂·6H₂O, AuCl₃, MgCl₂, Fe(ClO₄)₃, NiCl₂, H₂PtCl₅·6H₂O, Na₂PdCl₄, CuCl₂, and combinations thereof.

According to an embodiment of the present disclosure, the material of the porous substrate may be a polyolefin-based polymer resin.

According to an embodiment of the present disclosure, the material of the porous substrate may be a polyethylene resin or a polypropylene resin.

According to an embodiment of the present disclosure, the conductive polymer resin may be one selected from the group consisting of poly(pyrrole), poly(thiophene), poly(3,4-ethylenedioxythiophene), poly(phenylene sulfide), polyp-phenylene vinylene (poly(para-phenylene vinylene)), polyaniline, and combinations thereof.

According to an embodiment of the present disclosure, the inorganic material may be one selected from the group consisting of SiO₂, TiO₂, Al₂O₃, and combinations thereof.

According to an embodiment of the present disclosure, the coating layer may have a thickness of 10 nm or more and 200 nm or less.

According to an embodiment of the present disclosure, the gas phase polymerization may be performed in an inert gas atmosphere.

According to an embodiment of the present disclosure, the temperature at which the gas phase polymerization is performed may be 20° C. or more and 150° C. or less.

According to an embodiment of the present disclosure, when the conductive polymer resin is any one of poly(pyrrole), poly(thiophene), poly(3,4-ethylenedioxythiophene), or polyaniline, the conductive monomer may be one selected from the group consisting of pyrrole, thiophene, 3,4-ethylenedioxythiophene, aniline, and combinations thereof, and when the conductive polymer resin is poly(phenylene sulfide) or polyp-phenylenevinylene (poly(para-phenylene vinylene)), the conductive monomer may be one selected from the group consisting of 1,4-dibromobenzene, 1,4-dichlorobenzene, disodium sulfide, ethylene, and combinations thereof.

According to an embodiment of the present disclosure, the inorganic precursor may be one selected from the group consisting of tetraethyl orthosilicate (TEOS), titanium isopropoxide (TTIP), trimethylaluminum (TMA), and combinations thereof.

According to an embodiment of the present disclosure, the time during which the gas phase polymerization is performed may be 5 minutes or more and 60 minutes or less.

According to an embodiment of the present disclosure, the method may further include washing the porous substrate after the performing the gas phase polymerization.

According to an embodiment of the present disclosure, the washing is performed with ethanol, and the time during which the washing is performed may be 5 minutes or more and 60 minutes or less.

According to an embodiment of the present disclosure, the method may further include drying the porous substrate after the washing.

According to an embodiment of the present disclosure, the time during which the drying is performed may be 12 hours or more and 36 hours or less.

An embodiment of the present disclosure provides a lithium metal secondary battery including a negative electrode made of lithium metal, a positive electrode, and a separator for a lithium metal secondary battery, which is interposed between the positive electrode and the negative electrode, and is manufactured by the manufacturing method.

### Advantageous Effects

The method for manufacturing a separator for a lithium metal secondary battery according to an embodiment of the present disclosure can improve the energy density of the secondary battery, enables its manufacture under mild conditions such as atmospheric pressure and/or room temperature, and can improve heat resistance and electrical conductivity, by implementing the coating layer including the conductive polymer resin and the inorganic material as a thin film.

The lithium metal secondary battery according to an embodiment of the present disclosure can prevent the growth of lithium dendrite and side reactions on the surface of the lithium metal, thereby preventing performance degradation of the secondary battery and improving safety.

Effects of the present disclosure are not limited to the above-described ones, but other effects not described above will be clearly appreciated by those skilled in the art from the present specification and accompanying drawings.

### BRIEF DESCRIPTION OF DRAWINGS

FIG. 1 is a flowchart of a method for manufacturing a separator for a lithium metal secondary battery according to an embodiment of the present disclosure.

FIG. 2 is an SEM image and an EDS analysis picture of the surface of Example 1 according to an embodiment of the present disclosure.

FIG. 3 is an SEM image and EDS analysis picture of the surface of Comparative Example 1.

FIG. 4 is graphs showing discharge capacities according to the number of charge/discharge cycles of lithium metal secondary batteries manufactured using Example 1 according to an exemplary embodiment of the present disclosure and Comparative Examples 1 and 2.

FIG. 5 shows SEM image of the surfaces of lithium metals after the charge/discharge experiments of the lithium metal secondary batteries manufactured using Example 1 according to an embodiment of the present disclosure and Comparative Examples 1 and 2.

### MODE FOR INVENTION

Throughout this specification, when a part “includes” or “comprises” a component, it means not that the part excludes other component, but instead that the part may further include other component unless expressly stated to the contrary.

Throughout the specification of the present application, when a member is described as being located “on” another member, this includes not only a case in which the member is in contact with the other member but also a case in which another member exists between the two members.

Throughout this specification, the unit “parts by weight” may mean a ratio of weight between the respective components.

Throughout this specification, the phrase “A and/or B” refers to “A and B, or A or B.”

Hereinafter, the present disclosure will be described in more detail.

An embodiment of the present disclosure provides a method for manufacturing a separator for a lithium metal secondary battery, the method including: applying an oxidizing agent to a porous substrate having pores such that the pores are maintained; and performing gas phase polymerization of a mixture including a conductive monomer and an inorganic precursor on the porous substrate, such that a coating layer including a conductive polymer resin and an inorganic material is formed on at least a part of the porous substrate.

The method for manufacturing a separator for a lithium metal secondary battery according to an embodiment of the present disclosure can improve the energy density of the secondary battery, enables its manufacture under mild conditions such as atmospheric pressure and/or room temperature, and can improve heat resistance and electrical conductivity, by implementing the coating layer including the conductive polymer resin and the inorganic material as a thin film.

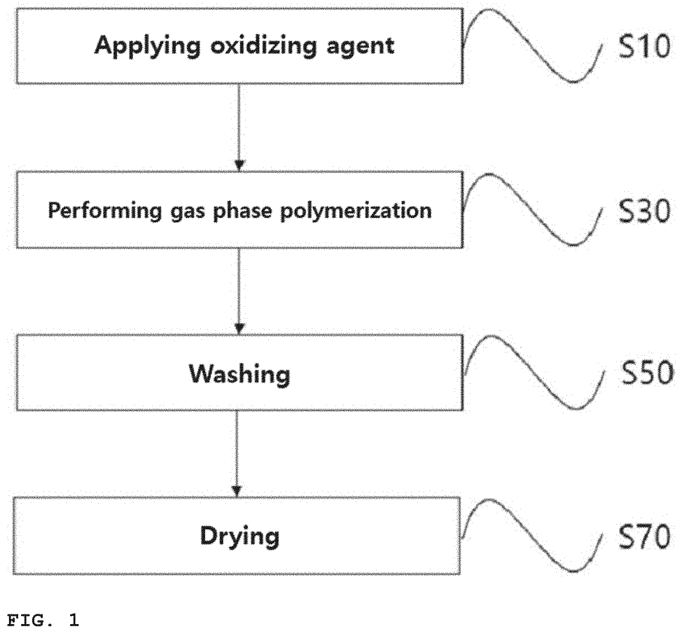

FIG. 1 is a flowchart of a method for manufacturing a separator for a lithium metal secondary battery according to an embodiment of the present disclosure. Referring to FIG. 1, the method for manufacturing a separator for a lithium metal secondary battery according to an embodiment of the present disclosure will be described in detail.

According to an embodiment of the present disclosure, the method includes applying an oxidizing agent to a porous substrate having pores such that these pores are maintained (S10). As described above, by including the step of applying the oxidizing agent to the porous substrate having pores such that these pores are maintained, in a gas phase polymerization process to be described later, it can serve to initiate polymerization of each of the conductive monomer and the inorganic precursor, and the pores can be maintained so that the electrolyte solution can move through the porous substrate.

According to an embodiment of the present disclosure, the porous substrate includes pores. Specifically, the porous substrate may include a multiple of penetrating pores on the entire surface thereof. As described above, since the porous substrate includes pores, electrolyte solution can move through the porous substrate.

According to an embodiment of the present disclosure, the surfaces of the insides of the pores in the porous substrate may be applied with an oxidizing agent such that the pores are not blocked by the oxidizing agent. As described above, since the surfaces of the insides of the pores in the porous substrate are applied with the oxidizing agent such that the pores are not blocked by the oxidizing agent, the electrolyte solution included in the separator using the porous substrate can maintain its movement, and the oxidizing agent serves as a reaction initiator, so that a coating layer including organic and inorganic materials can be formed under mild conditions.

According to an embodiment of the present disclosure, a part or all of the surfaces of the insides of the pores of the porous substrate and the outer surface of the porous substrate may be applied with an oxidizing agent. As described above, since a part or all of the surfaces of the insides of the pores of the porous substrate and the outer surface of the porous substrate are applied with an oxidizing agent, the oxidizing agent serves as a reaction initiator, so that a coating layer containing organic and inorganic materials can be formed under mild conditions.

According to an embodiment of the present disclosure, the method includes performing gas phase polymerization of a mixture including a conductive monomer and an inorganic precursor on the porous substrate, such that a coating layer including a conductive polymer resin and an inorganic material is formed on at least a part of the porous substrate (S30). As described above, since the method includes performing gas phase polymerization of a mixture including a conductive monomer and an inorganic precursor on the porous substrate, such that a coating layer containing a conductive polymer resin and an inorganic material is formed on at least a part of the porous substrate, the electrical conductivity and heat resistance of the porous substrate can be improved, and the coating layer can be formed as a thin film.

Throughout this specification, “gas phase polymerization” may mean polymerization into a polymer material by vaporizing an organic monomer and polymerizing the gaseous organic monomer, and may further mean forming an inorganic material by reacting the inorganic precursor in a vaporized state.

According to an embodiment of the present disclosure, a coating layer including a conductive polymer resin and an inorganic material may be formed on at least a part or all of the porous substrate. Specifically, the coating layer may be formed on a part or all of the surfaces of the insides of the pores of the porous substrate and the outer surface of the porous substrate. As described above, since the coating layer including the conductive polymer resin and the inorganic material is formed on at least a part or all of the porous substrate, the coating layer can be formed as a thin film on the porous substrate, and the pores can be maintained to allow the electrolyte solution to move therethrough.

According to an embodiment of the present disclosure, the coating layer is formed to maintain the pores of the porous substrate. As described above, by forming a conductive coating layer to maintain the pores of the porous substrate, electrical conductivity can be improved.

According to an embodiment of the present disclosure, a coating layer including a conductive polymer resin and an inorganic material may be formed on the porous substrate by performing the gas phase polymerization of a mixture including a conductive monomer and an inorganic precursor. As described above, since the coating layer including the conductive polymer resin and the inorganic material is formed on the porous substrate by performing the gas phase polymerization of a mixture including a conductive monomer and an inorganic precursor, the coating layer can be formed as a thin film under mild conditions such as atmospheric pressure and/or room temperature.

According to an embodiment of the present disclosure, the oxidizing agent may include one selected from the group consisting of FeCl₃, iron( [symbol] ) p-toluenesulfonate (ferric ( [symbol] ) p-toluenesulfonate), CuCl₃, Cu(ClO₄)₂·6H₂O, AuCl₃, MgCl₂, Fe(ClO₄)₃, NiCl₂, H₂PtCl₅·6H₂O, Na₂PdCl₄, CuCl₂, and combinations thereof. Specifically, the oxidizing agent is preferably iron ( [symbol] )-toluenesulfonate (ferric ( [symbol] ) p-toluenesulfonate). As described above, by selecting the oxidizing agent from the aforementioned group, the conductive monomer can be polymerized under mild conditions through the gas phase polymerization, and the inorganic material can be formed by reacting the inorganic precursor under mild conditions.

According to an embodiment of the present disclosure, the oxidizing agent may further include a solvent. Specifically, the oxidizing agent may further include 1-butanol as a solvent. Specifically, the oxidizing agent solution may be formed by dissolving the oxidizing agent in the solvent. As described above, since the oxidizing agent further includes the solvent, it can be easily performed to apply the oxidizing agent to the porous substrate.

According to an embodiment of the present disclosure, the content of the solvent may be 300 parts by weight or more, and 500 parts by weight or less based on 100 parts by weight of the oxidizing agent. Specifically, the content of the solvent is preferably 400 parts by weight based on 100 parts by weight of the oxidizing agent. As described above, by controlling the content of the solvent within the above-described range, the gas phase polymerization can be implemented under mild conditions, and overpolymerization can be prevented from occurring.

According to an embodiment of the present disclosure, the method may further include preparing the oxidizing agent (S5, not shown) before applying the oxidizing agent. As described above, by further including the preparing the oxidizing agent before the applying the oxidizing agent, it is possible to apply the oxidizing agent with an appropriate concentration to the porous substrate.

According to an embodiment of the present disclosure, the preparing the oxidizing agent (S5) may be to dissolve the oxidizing agent in the solvent by agitating them for 5 minutes or more, and 60 minutes or less. Specifically, in the preparing the oxidizing agent, it is preferable to dissolve the oxidizing agent in the solvent by agitating them for 10 minutes. As described above, since the preparing the oxidizing agent (S5) is implemented by dissolving the oxidizing agent in the solvent by agitating them for 5 minutes or more and 60 minutes or less, the oxidizing agent can be uniformly dissolved in the solvent, and the oxidizing agent solution with an appropriate concentration can be prepared.

According to an embodiment of the present disclosure, the applying the oxidizing agent (S10) may use any one of spin coating, bar coating, and dip coating. Specifically, it is preferable to use spin coating in the applying the oxidizing agent. As described above, since any one of spin coating, bar coating, and dip coating is selected to be used in the applying the oxidizing agent (S10), this step can be implemented such that the oxidizing agent of an appropriate amount is applied to the porous substrate while maintaining the pores of the porous substrate.

According to an embodiment of the present disclosure, the applying the oxidizing agent (S10) may be a second application after a first application. As described above, by implementing the applying the oxidizing agent (S10) as the second application after the first application, the oxidizing agent of an appropriate amount can be applied to the porous substrate while maintaining the pores of the porous substrate.

According to an embodiment of the present disclosure, the first application may be performed at a speed of 100 rpm or more and 500 rpm or less for 5 seconds or more and 15 seconds or less. Specifically, the first application is preferably performed at a speed of 300 rpm for 10 seconds. As described above, by performing the first application at a speed of 100 rpm or more and 500 rpm or less for 5 seconds or more and 15 seconds or less, the oxidizing agent of an appropriate amount can be applied to the porous substrate while maintaining the pores of the porous substrate.

According to an embodiment of the present disclosure, the second application may be performed at a speed of 400 rpm or more and 600 rpm or less for 15 seconds or more and 45 seconds or less. Specifically, the second application is preferably performed at a speed of 500 rpm for 30 seconds. As described above, by performing the second application at a speed of 400 rpm or more and 600 rpm or less for 15 seconds or more and 45 seconds or less, the oxidizing agent of an appropriate amount can be applied to the porous substrate while maintaining the pores of the porous substrate.

According to an embodiment of the present disclosure, the material of the porous substrate may be a polyolefin-based polymer resin. As described above, by implementing the material of the porous substrate with the polyolefin-based polymer resin, the sizes of the pores can be appropriately implemented and the basic physical properties required for a separator can be implemented.

According to an embodiment of the present disclosure, the material of the porous substrate may be a polyethylene resin or a polypropylene resin. As described above, by implementing the material of the porous substrate with the polyethylene resin or the polypropylene resin, the sizes of the pores can be appropriately implemented and the basic physical properties required for a separator can be implemented.

According to an embodiment of the present disclosure, the conductive polymer resin may be one selected from the group consisting of poly(pyrrole), poly(thiophene), poly(3,4-ethylenedioxythiophene), poly(phenylene sulfide), polyp-phenylene vinylene (poly(para-phenylene vinylene)), polyaniline, and combinations thereof. By selecting the conductive polymer resin from the aforementioned group, the coating layer can be implemented to have a thin thickness, to have an improved electrolyte solution wettability, and to suppress lithium dendrite growth.

According to an embodiment of the present disclosure, the inorganic material may be one selected from the group consisting of SiO₂, TiO₂, Al₂O₃, and combinations thereof. By selecting the inorganic material from the aforementioned group, the coating layer can be implemented to have a thin thickness, to improve the heat resistance of a separator, to improve the electrical conductivity of a separator, and to suppress lithium dendrite growth at the same time.

According to an embodiment of the present disclosure, the coating layer may have a thickness of 10 nm or more and 200 nm or less. By adjusting the thickness of the coating layer within the aforementioned range, it is possible to improve the energy density of a secondary battery by minimizing the weight increase of a separator.

According to an embodiment of the present disclosure, the gas phase polymerization may be performed inside a reactor. Specifically, the gas phase polymerization is preferably performed in a VPP chamber. As described above, by performing the gas phase polymerization inside the reactor, it is possible to minimize the inclusion of foreign substances in the coating layer by external substances.

According to an embodiment of the present disclosure, the gas phase polymerization may be performed in an inert gas atmosphere. As described above, by performing the gas phase polymerization in the inert gas atmosphere, it is possible to prevent a case where the conductive polymer resin and/or inorganic material are/is not formed in accordance with implementation intentions by external gas, and to minimize foreign substances.

According to an embodiment of the present disclosure, the inert gas may be one selected from the group consisting of N₂, CO₂, He, Ne, Ar, and combinations thereof. Specifically, the inert gas is preferably N₂. By selecting the inert gas from the aforementioned group, it is possible to prevent a case where the conductive polymer resin and/or inorganic material are/is not formed in accordance with implementation intentions by external gas, and to minimize foreign substances.

According to an embodiment of the present disclosure, in the gas phase polymerization process, the flow rate of the inert gas in the reactor may be 2 mL/s or more and 10 mL/s or less. Specifically, in the gas phase polymerization process, the flow rate of the inert gas in the reactor is preferably 6 mL/s. By adjusting the flow rate of the inert gas in the reactor within the above-described range during the gas phase polymerization process, it can be implemented to allow inorganic precursor and conductive monomer vaporized in the reactor to form a coating layer with an appropriate thickness on the porous substrate, while preventing external gas from being injected into the reactor and at the same time discharging foreign substances formed inside the reactor to the outside.

According to an embodiment of the present disclosure, specifically, the temperature at which the gas phase polymerization is performed may be 20° C. or more and 150° C. or less. The temperature of the gas phase polymerization is preferably 25° C. By controlling the temperature of the gas phase polymerization within the aforementioned range, it is possible to control the thickness of the coating layer while at the same time preventing the formation of undesired polymeric materials or inorganic materials caused by overheating, and improving the convenience of manufacturing a separator by making the reaction conditions mild.

According to an embodiment of the present disclosure, specifically, the time during which the gas phase polymerization is performed may be 5 minutes or more and 60 minutes or less. The gas phase polymerization time is preferably 30 minutes. As described above, by adjusting the gas phase polymerization time, it is possible to adjust the thickness of the coating layer, and to improve the convenience of manufacturing a separator by making the reaction conditions mild.

According to an embodiment of the present disclosure, if the conductive polymer resin is any one of poly(pyrrole), poly(thiophene), poly(3,4-ethylenedioxythiophene, or Polyaniline, the conductive monomer may be one selected from the group consisting of pyrrole, thiophene, 3,4-ethylenedioxythiophene, aniline, and combinations thereof. By selecting the conductive monomer from the aforementioned group, it is possible to implement a conductive polymer resin in accordance with the polymerization criteria.

According to an embodiment of the present disclosure, if the conductive polymer resin is poly(phenylene sulfide) or poly(para-phenylene vinylene), the conductive monomer may be one selected from the group consisting of 1,4-dibromobenzene, 1,4-dichlorobenzene, disodium sulfide, ethylene, and combinations thereof. Specifically, if the conductive polymer resin is poly(phenylene sulfide), the conductive monomer may be formed by the reaction of one selected from 1,4-dibromobenzene, 1,4-dichlorobenzene and combinations thereof with disodium sulfide, and specifically, if the conductive polymer resin is poly(para-phenylene vinylene), the conductive monomer may be formed by the reaction of one selected from 1,4-dibromobenzene, 1,4-dichlorobenzene and combinations thereof with ethylene. By selecting the conductive monomer from the aforementioned group, it is possible to implement a conductive polymer resin in accordance with the polymerization criteria.

According to an embodiment of the present disclosure, the conductive monomer is preferably pyrrole. By selecting the conductive monomer from the aforementioned group, it is possible to implement a conductive polymer resin in accordance with the polymerization criteria.

According to an embodiment of the present disclosure, the inorganic precursor may be one selected from the group consisting of tetraethyl orthosilicate (TEOS), titanium isopropoxide (TTIP), trimethylaluminum (TMA), and combinations thereof. By selecting the inorganic precursor from the aforementioned group, it is possible to form the inorganic material pursuant to the implementation intention.

According to an embodiment of the present disclosure, the time during which the gas phase polymerization is performed may be 5 minutes or more and 60 minutes or less. By adjusting the gas phase polymerization time within the aforementioned range, it is possible to adjust the thickness of the coating layer, and to improve the convenience of manufacturing a separator by making the reaction conditions mild.

According to an embodiment of the present disclosure, after the performing the gas phase polymerization (S30), washing the porous substrate (S50) may be further included. As described above, by further including the washing the porous substrate (S50) after the gas phase polymerization (S30), it is possible to remove the oxidizing agent remaining in a part of the porous substrate where the coating layer is not formed, thereby minimizing side reactions that may occur during the use of a separator.

According to an embodiment of the present disclosure, the washing is performed with ethanol, and the time during which the washing is performed may be 5 minutes or more and 60 minutes or less. Specifically, the washing is performed with ethanol, and the washing time is preferably 30 minutes. As described above, since the washing is performed with ethanol, and the washing time is 5 minutes or more and 60 minutes or less, it is possible to remove the oxidizing agent remaining in a part of the porous substrate where the coating layer is not formed, thereby minimizing side reactions that may occur during the use of a separator.

According to an embodiment of the present disclosure, after the washing (S50), drying the porous substrate (S70) may be further included. As described above, by further including the drying the porous substrate (S70) after the washing (S50), the remaining detergent and the like can be removed.

According to an embodiment of the present disclosure, the time during which the drying is performed may be 12 hours or more and 36 hours or less. The drying time is preferably 24 hours. By adjusting the drying time within the aforementioned range, it is possible to remove the remaining detergent and the like while minimizing the deformation of the porous substrate.

An embodiment of the present disclosure provides a lithium metal secondary battery including a negative electrode made of lithium metal, a positive electrode, and a separator for a lithium metal secondary battery, which is interposed between the positive electrode and the negative electrode, and is manufactured by the manufacturing method.

The lithium metal secondary battery according to an embodiment of the present disclosure can prevent the growth of lithium dendrite and side reactions on the surface of the lithium metal, thereby preventing performance degradation of the secondary battery and improving safety.

Hereinafter, the present disclosure will be described in detail with reference to examples. However, it should be noted that the examples according to the present disclosure may be modified into various other forms, and the scope of the present disclosure is not construed as being limited to the examples to be described below. The examples of the present specification are provided to more completely explain the present disclosure to those of ordinary skill in the art.

### Example 1

An oxidizing agent solution was manufactured by dissolving 20% by weight of iron( [symbol] ) p-toluenesulfonate (ferric ( [symbol] ) p-toluenesulfonate (FTS)), an oxidizing agent, in 1-butanol, a solvent, while agitating them for about 10 minutes. The oxidizing agent solution was applied for the first time to a porous substrate made of polyethylene resin by performing spin coating at 300 rpm for 10 seconds, and then consecutively applied for the second time thereto by performing spin coating at 500 rpm for 30 seconds.

A VPP chamber, which is a reactor having an inlet and an outlet, was prepared, and N₂ was supplied to the reactor at a flow rate of 6 mL/s before the gas phase polymerization. Thereafter, pyrrole (Py) monomer as a conductive monomer and tetraethoxysilane (TEOS) as an inorganic precursor were placed and vaporized for a short time in the center of the reactor, the VPP chamber, before starting the gas phase polymerization. Thereafter, the gas phase polymerization was performed at 25° C. for 30 minutes to form a coating layer, and then the coated porous substrate was washed with ethanol for 30 minutes to remove unreacted oxidizing agent, and was dried for 24 hours, whereby a separator for a lithium metal secondary battery was manufactured.

### Comparative Example 1

A separator for a lithium metal secondary battery was manufactured in the same method as in Example 1, except that tetraethoxysilane (TEOS), an inorganic precursor, of Example 1 was not used.

### Comparative Example 2

A separator for a lithium metal secondary battery was manufactured only with the porous substrate made of the polyethylene resin.

### Experimental Example 1 (Evaluation of Presence/Absence of a Coating Layer Including Conductive Polymer Resin and Inorganic Material)

In order to evaluate the characteristics of the separators for a lithium metal secondary battery manufactured in Example 1 and Comparative Example 1 above, it was evaluated, through SEM image analysis and EDS mapping based on the SEM image analysis, whether these separators for a lithium metal secondary battery were manufactured such that the components included in the conductive monomer and the inorganic precursor were appropriately coated on the porous substrate.

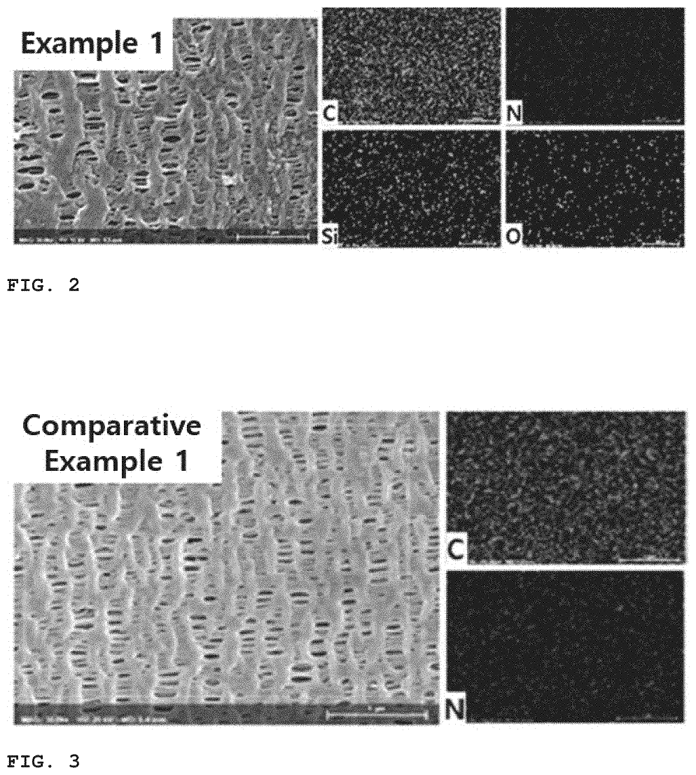

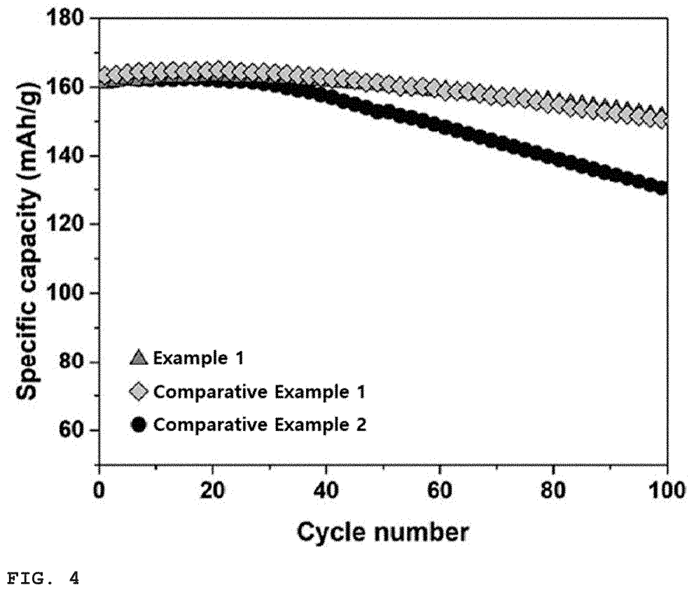

FIG. 2 is an SEM image and an EDS analysis picture of the surface of Example 1 according to an embodiment of the present disclosure. FIG. 3 is an SEM image and EDS analysis picture of the surface of Comparative Example 1. Referring to FIGS. 2 and 3, in Example 1, Si and O atoms, which are components of tetraethoxysilane used as the inorganic precursor, were checked, and C and N atoms, which are components of pyrrole used as the conductive monomer, were checked.

In contrast, Comparative Example 1 did not include tetraethoxysilane used as an inorganic precursor, so it was confirmed that Si and O atoms, which are components of tetraethoxysilane, were not present.

### Experimental Example 2 (Evaluation of Heat Resistance Characteristics)

In order to measure the thermal contraction rates of the separators for a lithium metal secondary battery manufactured in Example 1, Comparative Example 1, and Comparative Example 2 above, the following method was performed.

A total of three samples were manufactured by cutting the separators for a lithium metal secondary battery manufactured in Example 1, Comparative Example 1, and Comparative Example 2 above into a width (MD) of 2 cm×length (TD) of 2 cm. Each of the samples was stored and heated in a chamber at 150° C. for 1 hour, and then the degree of shrinkage of each sample was checked.

In Table 1 below, one having a degree of thermal shrinkage of 40% or more was evaluated as having poor heat resistance and marked with “X”, and one having a degree of thermal shrinkage of less than 40% was evaluated as having excellent heat resistance and marked with “O”.

The thermal shrinkage was calculated by Equation 1 below.

Thermal shrinkage (%)=[(area of initial specimen area of specimen after heating)/area of initial specimen]*100% [Equation 1]

### Experimental Example 3 (Evaluation of Electrical Conductivity Characteristics)

In order to measure the electrical conductivities of the separators for a lithium metal secondary battery manufactured in Example 1, Comparative Example 1, and Comparative Example 2 above, the following method was performed.

The electrical conductivities were compared through sheet resistance measurement results, and the electrical conductivity has an inversely proportional relationship with the sheet resistance measurement value.

A total of three samples were manufactured by cutting each of the separators for a lithium metal secondary battery into a width (MD) of 5 cm×length (TD) of 5 cm. After drying the samples in a vacuum oven at 50° C. for 6 hours, the surface resistance of the samples was measured on their surfaces using a sheet resistance measuring device.

In Table 1 below, when sheet resistance was not measured and electrical conductivity could not be evaluated, it was marked with “Not Measurable”, and a sheet resistance of 5 kQ/sq or less was considered to represent the general level of electrical conductivity of a conductive polymer coating layer, and was marked with “O”.

### Experimental Example 4 (Evaluation of Electrolyte Solution Wettability Characteristics)

In order to measure the electrolyte solution wettability of the separators for a lithium metal secondary battery manufactured in Example 1, Comparative Example 1, and Comparative Example 2 above, the following method was performed.

The electrolyte solution wettability was evaluated by the electrolyte solution impregnation rate, and circular disk-shaped samples having a diameter of 19 mm were each manufactured from the separators for a lithium metal secondary battery manufactured in Example 1, Comparative Example 1, and Comparative Example 2 above. After drying the samples in a vacuum oven at 50° C. for 6 hours, they were sufficiently impregnated with the electrolyte solution, and the amounts of the electrolyte solution impregnated into them were checked.

The electrolyte solution used in the measurement employed a solvent in which the volume ratio of ethylene carbonate (EC):ethylmethyl carbonate (EMC) was 3:7 (vol %), and a solute which was lithium hexafluorophosphate (LiPFE).

The electrolyte solution wettability was evaluated using the electrolyte solution impregnation rate calculated by Equation 2 below, and as shown in Table 1, if the electrolyte solution impregnation rate was equal to or less than the reference 100% of the standard, it was marked with “X”, and if the electrolyte solution impregnation rate was greater than the reference 100% of the standard, it was marked as O.

Electrolyte solution impregnation rate (%)=[(mass of sample after electrolyte solution impregnation−mass of dried initial sample)/mass of dried initial sample]*100% [Equation 2]

TABLE 1

| | | Comparative | Comparative |
|---|---|---|---|
| | Example 1 | Example 1 | Example 2 |
| Heat Resistance | ◯ | X | X |
| Electrical Conductivity | ◯ | ◯ | Not Measurable |
| Electrolyte Solution | ◯ | ◯ | X |
| Wettability | | | |

Referring to Table 1, it was confirmed that Example 1, in which the coating layer was formed by the gas phase polymerization of the mixture including the conductive monomer and the inorganic precursor, exhibited excellent heat resistance, electrical conductivity, and electrolyte solution wettability. In contrast, it was confirmed that Comparative Example 1, in which the coating layer was formed by the gas phase polymerization of the mixture including no inorganic precursor, exhibited poor heat resistance, and it was confirmed that Comparative Example 2 using only polyethylene resin exhibited poor heat resistance, electrical conductivity, and electrolyte solution wettability.

### Experimental Example 5 (Evaluation of Charge/Discharge Characteristics)

Charge/discharge life characteristics were checked using, as a charge/discharge device, batteries which had been manufactured using a 1 M electrolyte solution, a positive electrode of LiNi_{0.6}Mn_{0.2}Co_{0.2}O₂ (NMC 622), a negative electrode made of lithium metal with a thickness of 450 μm, and separators for a lithium metal secondary battery manufactured in Example 1, Comparative Example 1 and Comparative Example 2, wherein the electrolyte solution employed a solvent in which the volume ratio of ethylene carbonate (EC):ethylmethyl carbonate (EMC) was 3:7 (vol %), and a solute which was lithium hexafluorophosphate (LiPF₆).

FIG. 4 is graphs showing discharge capacities according to the number of charge/discharge cycles of lithium metal secondary batteries manufactured using Example 1 according to an exemplary embodiment of the present disclosure and Comparative Examples 1 and 2. Referring to FIG. 4, it was confirmed that Example 1 and Comparative Example 2 exhibited similar levels of discharge capacities, but Comparative Example 2 using only polyethylene resin exhibited poor discharge capacity.

### Experimental Example 6 (Lithium Metal Surface Analysis after Charging and Discharging)

After performing the charge/discharge cycles in Experimental Example 4, the batteries were disassembled, and the surface analysis of lithium metal negative electrode was performed.

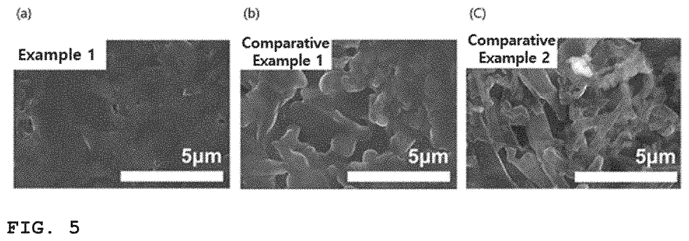

FIG. 5 shows SEM image of the surfaces of lithium metals after the charge/discharge experiments of the lithium metal secondary batteries manufactured using Example 1 according to an embodiment of the present disclosure and Comparative Examples 1 and 2. Referring to FIG. 5, in Example 1 in which the coating layer was formed by the gas phase polymerization of the mixture including the conductive monomer and the inorganic precursor, it was confirmed that there was almost no growth of lithium dendrite. Contrarily, in Comparative Example 1 in which the coating layer was formed by the gas phase polymerization of the mixture including no inorganic precursor, it was confirmed that lithium dendrite grew to a certain degree, and in Comparative Example 2 using only polyethylene resin, it was confirmed that a large amount of lithium dendrite was generated.

Therefore, according to an embodiment of the present disclosure, it is confirmed that, by forming a coating layer as a thin film on a porous substrate through gas phase polarization of a mixture containing a conductive monomer and an inorganic precursor, the growth of lithium dendrite can be suppressed, and heat resistance, electrical conductivity and electrolyte solution wettability can be improved.

While the present disclosure has been described by limited embodiments until now, the present disclosure is not limited by them, and various changes and modifications can be made by those skilled in the art to which the present disclosure pertains without departing from the equivalent scope of the technical idea of the present disclosure and the claims to be provided below.

### REFERENCE SIGN LIST

S5: Preparing oxidizing agent
S10: Applying oxidizing agent
S30: Performing gas phase polymerization
S50: Washing
S70: Drying

1. A method for manufacturing a separator for a lithium metal secondary battery, the method comprising:
applying an oxidizing agent to a porous substrate having pores such that the pores are maintained; and
performing gas phase polymerization of a mixture including a conductive monomer and an inorganic precursor on the porous substrate, such that a coating layer including a conductive polymer resin and an inorganic material is formed on at least a part of the porous substrate.

2. The method of claim 1, wherein the oxidizing agent includes one selected from the group consisting of FeCl₃, iron( [symbol] ) p-toluenesulfonate (ferric ( [symbol] ) p-toluenesulfonate), CuCl₃, Cu(ClO₄)₂·6H₂O, AuCl₃, MgCl₂, Fe(ClO₄)₃, NiCl₂, H₂PtCl₅·6H₂O, Na₂PdCl₄, CuCl₂, and combinations thereof.

3. The method of claim 1, wherein the material of the porous substrate is a polyolefin-based polymer resin.

4. The method of claim 3, wherein the material of the porous substrate is a polyethylene resin or a polypropylene resin.

5. The method of claim 1, wherein the conductive polymer resin is one selected from the group consisting of poly(pyrrole), poly(thiophene), poly(3,4-ethylenedioxythiophene), poly(phenylene sulfide), polyp-phenylene vinylene (Poly(para-phenylene vinylene)), polyaniline, and combinations thereof.

6. The method of claim 1, wherein the inorganic material is one selected from the group consisting of SiO₂, TiO₂, Al₂O₃, and combinations thereof.

7. The method of claim 1, wherein the coating layer has a thickness of 10 nm or more and 200 nm or less.

8. The method of claim 1, wherein the gas phase polymerization is performed in an inert gas atmosphere.

9. The method of claim 1, wherein temperature at which the gas phase polymerization is performed is 20° C. or more and 150° C. or less.

10. The method of claim 1, wherein when the conductive polymer resin is any one of poly(pyrrole), poly(thiophene), poly(3,4-ethylenedioxythiophene), or polyaniline, the conductive monomer is one selected from the group consisting of pyrrole, thiophene, 3,4-ethylenedioxythiophene, aniline, and combinations thereof, and
wherein when the conductive polymer resin is poly(phenylene sulfide) or polyp-phenylenevinylene (poly(para-phenylene vinylene)), the conductive monomer is one selected from the group consisting of 1,4-dibromobenzene, 1,4-dichlorobenzene, disodium sulfide, ethylene, and combinations thereof.

11. The method of claim 1, wherein the inorganic precursor is one selected from the group consisting of tetraethyl orthosilicate (TEOS), titanium isopropoxide (TTIP), trimethylaluminum (TMA), and combinations thereof.

12. The method of claim 1, wherein time during which the gas phase polymerization is performed is 5 minutes or more and 60 minutes or less.

13. The method of claim 1, further comprising washing the porous substrate after the performing the gas phase polymerization.

14. The method of claim 13, wherein the washing is performed with ethanol, and
wherein time during which the washing is performed is 5 minutes or more and 60 minutes or less.

15. The method of claim 13, further comprising drying the porous substrate after the washing.

16. The method of claim 15, wherein time during which the drying is performed is 12 hours or more and 36 hours or less.

17. A lithium metal secondary battery comprising a negative electrode made of lithium metal, a positive electrode, and a separator for a lithium metal secondary battery, wherein the separator is interposed between the positive electrode and the negative electrode, and is manufactured by a method according to claim 1.
